(19) United States
(12) Patent Application Publication
(10) Pub. No.: US 2004/0213731 A1
(43) Pub. Date: Oct. 28, 2004

(54) Iron oxide based materials for use as ion intercalation hosts in rechargeable lithium batteries

(76) Inventors: Jun Xu, Piscataway, NJ (US); Gaurav Jain, Piscataway, NJ (US)

Correspondence Address: Kenneth Watov, Esq., WATOV & KIPNES, P.C., P.O. Box 247, Princeton Junction, NJ, 08550, US

(21) Appl. No.: 10/742,272

(22) Filed: Dec. 19, 2003

Related U.S. Application Data
(60) Provisional application No. 60/437,984, filed on Jan. 6, 2003.

(51) Int. Cl. C01G 49/02

(52) U.S. Cl. 423/633

(57) ABSTRACT

An iron oxide based host material capable of intercalating lithium ions includes nanostructured phases composed of at least substantially amorphous nanometer sized particles, and is applicable for use in the cathode electrode of a lithium rechargeable battery.

### RELATED APPLICATION

The present Application claims priority to U.S. Provisional Patent Application Serial No. 60/437,984, filed Jan. 16, 2003, entitled “IRON-BASED ELECTRODE MATERIALS FOR LITHIUM BATTERIES,” the content of which is hereby incorporated by reference herein to the extent that it does not conflict herewith.

### FIELD OF THE INVENTION

The present invention is related generally to amorphous iron oxide based materials exhibiting electrochemical properties, and more particularly to nanostructured amorphous iron oxide based materials for use as electrode components in rechargeable lithium batteries, and methods for making and using the same.

### BACKGROUND OF THE INVENTION

A variety of transition metal compounds including, for example, cobalt oxides and manganese oxides, serve as intercalation hosts for lithium. The capacity for such host materials, or ion intercalation materials, to intercalate lithium is a major factor in determining the charge/discharge capacity and energy density of rechargeable lithium batteries. The selection for specific applications is typically driven by various considerations including cost, performance, environmental compatibility, and reliability. Rechargeable lithium and lithium-ion batteries are the most promising rechargeable battery systems existing today due in part to their higher specific energies and longer operating life compared to other systems.

Such rechargeable battery systems are typically composed of a cathode, which allows reversible insertion and removal of positive ions into/from its structure. In lithium battery systems, lithium ions reside in the anode when the cell is in the fully charged state. During discharge, the ions move through an electrolyte to the cathode where they are intercalated into the host structure of the cathode. Simultaneously, in the external circuit, electrons move from the anode to the cathode, yielding electrical energy. When the cell is being charged, the ions de-intercalate from the cathode and return to the anode. Such cells have the advantage that only minor physical changes occur to the electrodes during the charging and discharging processes, and the electrolyte is not decomposed but simply serves as a conductor of the ions. Consequently, such cells can be recharged many more times than, for example, a lead-acid accumulator.

Traditional host materials are typically composed of crystalline transition metal oxides such as cobalt oxides and nickel oxides. Crystalline oxides are usually synthesized through solid-state routes under high temperature conditions. Such synthesis routes generally yield materials containing thermodynamically stable phases with particle sizes in the micrometer range. One popular crystalline oxide is lithium cobalt oxide, the predominant host material in current rechargeable batteries. Lithium cobalt oxide is known to be highly toxic to the environment and costly to fabricate. These shortcomings have spurred a search for a suitable host material that is cheaper to make and more friendly to the environment, while exhibiting the same or at least similar performance capabilities as the lithium cobalt oxides.

Lithium intercalation into crystalline, micron-sized α-Fe₂O₃ was investigated in the early 1980's. Structurally, the ferric oxide host material was expected to allow intercalation of up to 2 Li per Fe₂O₃. However, the host material was observed to undergo a severely detrimental structural transformation due to large strains generated from the intercalation of a relatively small amount of lithium (about 0.1 Li/Fe₂O₃) changing the crystalline structure from its hexagonal anion packing configuration to a cubic anion packing configuration. The ferric oxide host materials are typically composed of iron oxides exhibiting conventional crystalline structures and micrometer particles (i.e., microcrystalline ferric oxides) have produced disappointing results including sluggish intercalation kinetics, low voltage characteristics and poor reversibility. Microcrystalline ferric oxide has also been reported to exhibit specific capacities in the range of from about 20 to 50 milliampere-hour per gram (mAh/g) at finite current rates at the voltage range associated with cathodes. To provide performance comparable to lithium cobalt oxide, the cathode candidate should preferably exhibit a specific capacity of at least 140 mAh/g while providing good reversibility. Recent research has shifted towards developing other kinds of metal-based oxides including crystalline ferric oxides composed of nano-sized crystalline particles which yield improved electrochemical performance over larger size particles (e.g. micrometer size).

Accordingly, there is a need to develop and produce an amorphous nanostructured iron oxide host material, which exhibits electrochemical properties including enhanced intercalation capacity, excellent rate capacity and capacity retention upon recharge/discharge cycling. There is a need to develop a synthesis route, which produces the amorphous nanostructured iron oxide host material in a simple and cost efficient manner. There is a further need to produce a lower cost and more environmentally friendly cathode material for use in rechargeable batteries.

### SUMMARY OF THE INVENTION

The present invention is related to an iron oxide-based host material for use as an ion intercalation host in rechargeable lithium batteries, and to a method for making the iron oxide-based host material. In particular, the iron oxide-based host material in the form of nanostructured ferric oxide, which exhibits thermodynamic and kinetic properties including ion intercalation capacity surprisingly different from microcrystalline ferric oxide, has been found useful for forming nanostructured intercalation compounds as electrodes for rechargeable lithium batteries. In accordance with the present invention, these iron oxide-based host materials are composed of nanometer sized particles exhibiting nanostructured morphology and relatively high surface areas to yield enhanced cathodic performance. Thus, the amorphous nanostructured forms of ferric oxide in the present invention are especially useful as cathode electrodes for rechargeable lithium batteries.

Furthermore, the nanostructured ferric oxide of the present invention is preferably produced through relatively low-temperature aqueous solution routes, thus enabling synthesis to be carried out in a relatively simple, cost effective and environmentally friendly manner. Particular attention has been directed to the synthesis of amorphous forms of ferric oxide composed of nanometer sized particles using such soft chemistry procedures.

The present invention is directed to nanostructured ferric oxides for use as intercalation host materials for lithium rechargeable batteries. The short-range order structure and nanostructured morphology of the iron oxide based host material exhibits excellent electrochemical performance that is far superior to the performance reported for any microcystalline form of iron oxide or lithium iron oxide. The low cost and environmental friendliness of the present nanostructured ferric oxide, coupled with its performance, make it a desirable cathode candidate for rechargeable lithium batteries.

In one aspect of the present invention, there is provided an iron oxide based material for use as an ion intercalation host, which comprises a nanostructured ferric oxide produced via aqueous oxidative hydrolysis and heat treatment.

In a further aspect of the present invention, there is provided an iron oxide material capable of intercalating lithium ions comprising nanostructured phases composed of at least substantially amorphous nanometer sized particles.

In another aspect of the present invention, there is provided a method for preparing an iron oxide material capable of intercalating lithium ions, comprising the steps of:

oxidizing Fe(II) via hydrolysis to yield FeOOH; and

dehydrating FeOOH at a temperature and for a time sufficient to yield nanostructured phases composed of at least substantially amorphous nanometer size particles of Fe₂O₃.

In a further aspect of the present invention, there is provided an iron oxide based material for use as an ion intercalation host produced through the steps of the method of the present invention.

### BRIEF DESCRIPTION OF THE DRAWINGS

Various embodiments of the invention are described in detail below with reference to the drawings, in which like items are identified by the same reference designation, wherein:

FIG. 1 shows a flowchart depicting the steps for synthesizing an amorphous nanostructured ferric oxide in accordance with one embodiment of the present invention.

FIG. 2 depicts x-ray powder diffraction (XRD) measurements of (a) a largely amorphous form of α-iron oxyhydroxide (α-FeOOH) formed prior to heat treatment; (b) an amorphous nanostructured form of α-ferric oxide obtained by heating α-FeOOH at 250° C. in air for 24 hours; and (c) an amorphous nanostructured form of α-ferric oxide obtained by heating α-FeOOH at 500° C. in air for 48 hours;

FIG. 3 is an image produced from a transmission electron microscope of an amorphous nanostructured ferric oxide (Fe₂O₃) showing a nanostructured morphology with characteristic length of particles in the range of a few to a few tens of nanometers, and a selected area electron diffraction (SAED) pattern revealing a nanostructured structure;

FIG. 4 a graph showing the discharge curve of nanostructured Fe₂O₃ at C/50 or 58.8 μA/cm² and that of microcrystalline α-Fe₂O₃;

FIG. 5 is a graph showing the discharge curve of nanostructured Fe₂O₃ at C/5 or 0.5 mA/cm² and that of microcrystalline α-Fe₂O₃ at 0.25 mA/cm²; and

FIG. 6 is a graph showing the specific discharge capacity versus cycle number of the nanostructured iron oxide sample at 0.5 mA/cm².

### DETAILED DESCRIPTION OF THE INVENTION

The present invention is directed generally to an iron oxide material capable of intercalating lithium ions and a method for preparing the same. The iron-based amorphous oxides of the present invention are readily produced through relatively low temperature soft chemistry routes of synthesis. The iron based amorphous oxides have been found to exhibit metastable structures and nanostructured morphology wherein the particle sizes of the material are within the nanometer range. The amorphous oxides of the present invention have generally been found to exhibit enhanced electrochemical properties as compared to the corresponding crystalline counterparts. The iron-based amorphous oxides are known to exhibit desirable qualities including relatively high intercalation capacities, and specific energies, and reduced susceptibility to irreversible phase changes over conventionally produced crystalline iron oxides containing micrometer sized particles.

Applicants note that microcrystalline α-Fe₂O₃ has been investigated in the past for lithium intercalation, but was quickly abandoned due to its poor performance. The amorphous nanostructured ferric oxide (Fe₂O₃) of the present invention, has a structure that is similar to the structure of crystalline α-Fe₂O₃, however, each exhibits drastically different intercalation properties. In particular, it has been found that nanostructured ferric oxide exhibits high specific capacity and excellent capacity retention upon cycling, along with low cost and non-toxicity, making it an attractive cathode candidate for rechargeable lithium batteries.

Iron oxides have been found to be an attractive alternative to cobalt and nickel-based oxides from cost and environmental standpoints. Applicants have found that iron oxides, which possess nanostructured morphology, avoid the problems of phase transformations and sluggish kinetics typically associated with conventional microcrystalline iron oxides. Shorter diffusion lengths and facile diffusion due to the large fraction of disordered surface structure are some of the characteristics associated with nanostructured morphology, and generally result in relatively high intercalation capacities at practical discharge rates. Moreover, the nanostructured iron oxides of the present invention exhibit increased contribution from surface energy for significant reduction in detrimental phase transformations, thus enhancing reversibility. Applicants have discovered that an increase in the porosity of the iron-based oxide enhances the lithium intercalation kinetics resulting in a higher intercalation capacity for a given rate. Applicants have further discovered that the less crystalline the iron oxide based material the more isotropic the volume changes associated with intercalation become, thus reducing the tendency for structural disintegration of the cathode and yielding enhanced cycling performance. Applicants theorize that the nanostructured and substantially amorphous structure of the compound and the low temperature synthesis route employed for its synthesis yields a material that is characterized by a higher occurrence of defects and cationic vacancies in the structure. Applicants further believe that such vacancies can serve as facile pathways for lithium transport and may also act as additional sites for lithium intercalation.

The amorphous ferric oxide host material of the present invention has been found to be a stable intercalation host for lithium with an intercalation capacity of at least 0.5 Li per mole of lithium per of Fe₂O₃. The host material of the present invention remains amorphous over the range of intercalation conditions and the insertion process is reversible. When used as an intercalation cathode for lithium-based batteries, the material yields a charge or specific capacity of at least 80 mAh/g, and preferably at least 195 mAh/g, and stores energy at the level of at least 400 mWh/g, preferably from about 400 to 550 mWh/g.

The present invention is further directed to iron oxide based materials useful as ion intercalation hosts, and in particular lithium intercalation hosts for use in rechargeable battery electrodes (i.e., cathodes). Further, the present invention is directed to the synthesis of the iron oxide based materials composed of an amorphous nanostructured ferric oxide synthesized through an aqueous oxidative hydrolysis procedure followed by a heat treatment to yield the desired product.

The iron oxide based material is a ferric oxide compound which exhibits a nanostructured, at least substantially amorphous, α-Fe₂O₃, which can be synthesized using low temperature soft chemistry processes. The synthesis method generally comprises preparing an aqueous solution of a soluble Fe(II) salt which is oxidized in the presence of strongly alkaline conditions (e.g., pH˜11 to 12) to yield a precipitate. Suitable Fe(II) salts for the synthesis include, for example, FeCl₂, Fe(NO₃)₂, Fe(CH₃COO)₂ and the like. The pH level is selected to facilitate the precipitation of the phase α-FeOOH or goethite. The powder precipitates can be separated from the reaction mixture through centrifuging and processed by freeze-drying techniques. Thereafter, the α-FeOOH product is exposed to heat at a temperature and for a time sufficient to facilitate dehydration to yield an amorphous, nanostructured ferric oxide.

The term “amorphous” is used herein to describe a solid that is not crystalline (i.e., one that has no long-range order in the lattice), and encompasses a range of local atomic arrangements and compositions, wherein X-ray powder diffraction may not be capable of distinguishing the difference among them, but may require more detailed structural analysis by other techniques to reveal the differences among different amorphous structures. The term “nanostructured” are used to characterize a solid composed of a short-range structure generally in particle forms ranging in size of from 1 to 100 nanometers, and preferably about 30 nanometers.

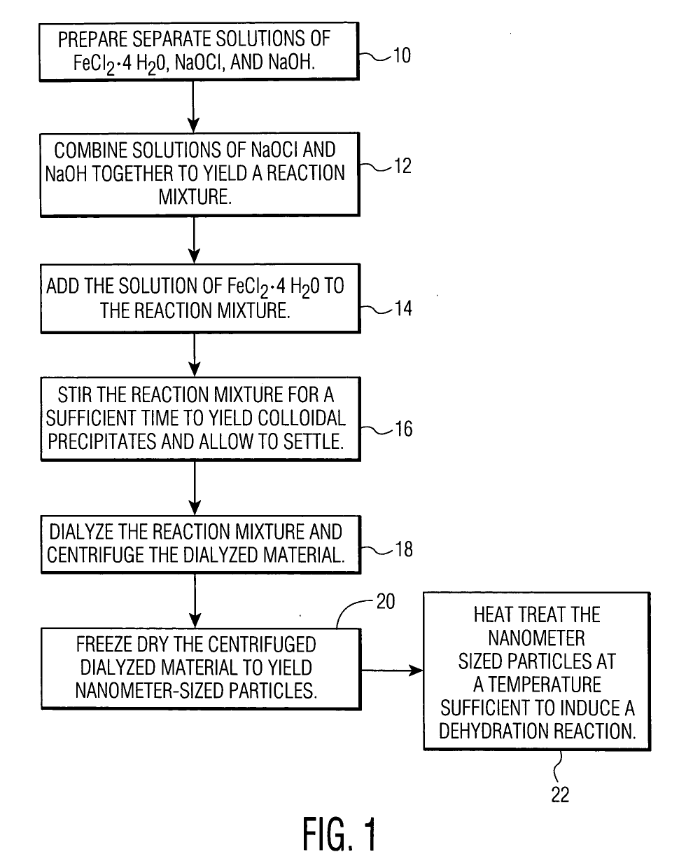

With reference to FIG. 1, a flowchart illustrates the steps for synthesizing the amorphous nanostructured ferric oxide in one embodiment of the present invention. Solutions containing one of following: iron chloride (FeCl₂), sodium hypochlorite (NaOCl) and sodium hydroxide (NaOH) are prepared separately in a molar ratio for FeCl₂:NaOCl:NaOH of about 1:2.5:5 as indicated in step 10. The solutions containing NaOCl and NaOH are combined and thoroughly mixed to yield a reaction mixture having a pH of about 12 as indicated in step 12. The solution containing FeCl₂ is added to the reaction mixture and thoroughly stirred as indicated in step 14. The Fe²⁺ species is oxidized to yield species of higher valence, including Fe³⁺ in the form of colloidal FeOOH precipitates. The resulting reaction mixture is stirred for a sufficient time, preferably about 1.5 hours, and then allowed to stand for about 24 hours to permit the precipitates to settle out as indicated in step 16. The reaction mixture is thereafter washed and dialyzed for about 5 days using low pass dialysis films in deionized water with the resulting dialyzed material centrifuged as indicated in step 18. The centrifuged dialyze material is subsequently freeze-dried to yield nanometer-sized iron oxyhydroxide particles as indicated in step 20.

The nanometer-sized iron oxyhydroxide (FeOOH) particles are then heat treated to a temperature sufficient to initiate dehydration in the presence of ambient air while maintaining the structure in an amorphous form as indicated in step 22. The heat treatment temperature is in the range of from about 250° C. to 500° C. for 24 to 48 hours in the presence of air to yield the desired amorphous ferric oxide powders. The Brunauer-Emmett-Teller (BET) specific surface area of the prepared nanostructured materials is typically around 250 m²/gm.

Applicants carried out an X-ray diffraction analysis to determine the chemical make up of the precipitate produced by the aqueous oxidation reaction, and it was determined from the analysis that the precipitate was an amorphous form of iron oxyhydroxide (α-FeOOH). Upon heat treatment, a nanostructured amorphous ferric oxide is formed through dehydration of the iron oxyhydroxide precipitate. Applicants determined that the temperature of the heat treatment was critical to maintaining the amorphous structure of the desired product. Applicants observed that by heating the iron oxyhydroxide material at higher temperature specifically at temperatures above 500° C., the final product was found to exhibit a more crystalline structure.

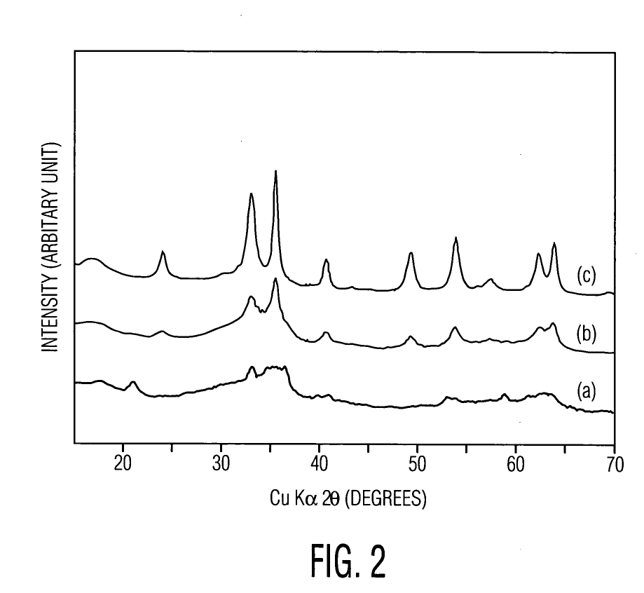

With reference to FIG. 2, powder X-ray diffraction (XRD) measurements were carried out using Cu Kα radiation, with a graphite monochromator mounted between a sample produced by the synthesis procedure described above, and the detector to prevent interference from the Fe Kα fluorescence. Elemental analysis by atomic absorption reveals a very small amount of sodium (0.01 Na per Fe) in the freeze-dried powder. An X-ray diffraction (XRD) analysis of the powder precipitates identified by (a) indicates that the material is a structurally disordered or amorphous form of α-FeOOH. The synthesis method further comprises a second step where the resulting powder precipitates (i.e., α-FeOOH) is heated to an elevated temperature for a sufficient time in ambient air to dehydrate the material while at least substantially maintaining the amorphous structure to yield α-Fe₂O₃. In a preferred embodiment of the present invention, the powder precipitate is heated to a temperature of up to 500° C., more preferably about 250° C., for about 24 hours.

Referring back to FIG. 2, an XRD analysis identified by (b) is made of the resulting product which was produced from heating the precipitate at about 250° C. shows all peaks corresponding to α-Fe₂O₃ or hematite. The peaks in the spectrum are not sharp which suggests that the material is substantially amorphous with short-range order, and not absolutely crystalline. The XRD pattern (b) of the product heat treated at 250° C. in air for about 24 hours shows broad peaks of weak intensity, clearly indicating absence of long range order.

An XRD analysis identified by (c) is made of the resulting product which was produced by heating the precipitate at about 500° C. shows sharper and more defined peaks, thus indicating a more crystalline structure. Accordingly, by dehydrating the precipitate at a lower temperature, preferably less than 500° C., the iron oxide based material exhibits the desired amorphous structure useful in the present invention as lithium ion intercalation hosts. The XRD pattern (c) of the product heat treated at 500° C. for about 48 hours shows higher peak intensities and narrower peak widths at the corresponding peaks, indicating an longer range order than product of (b).

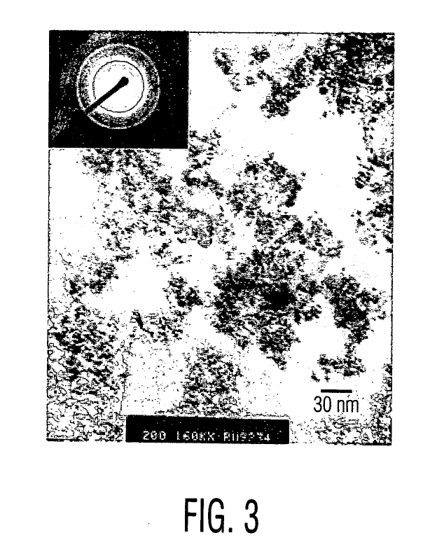

Referring to FIG. 3, a transmission electron microscope (TEM) image of a nanostructured iron oxide based material of the present invention is shown to illustrate the nanostructured morphology. The TEM image confirms a nanostructured morphology with the characteristic length of the particles in the range of from about 1 to 100 nanometers. The inset of FIG. 3 shows a selected area electron diffraction pattern, which indicates a partially crystalline structure in the material. Brunauer-Emmett-Teller (BET) surface area analysis indicates that the iron oxide based material exhibits a specific surface area of at least 250 m²/g, which is characteristic of nanostructured morphology. The iron oxide based material of the present invention is characterized by low or poor crystallinity, substantial meso/microporosity with high specific surface area, and imperfectly shaped particles. The typical composition of the heated product can be presented as NaₓFe₂O_{3+x/2} with 0≦x≦0.25, varying with the ratios of the reactants used.

The nanostructured ferric oxide of the present invention including Fe₂O₃ is generally characterized by a substantially amorphous structure which can be indicated by a the x-ray diffraction pattern of the material which exhibits broad peaks with an fullwidth at half maximum value of about 0.3° to 1.5° Cu Kα 2θ. The nanostructured ferric oxide further exhibits high meso/microporosity with a total surface area of at least 250 m²/g.

### EXAMPLE

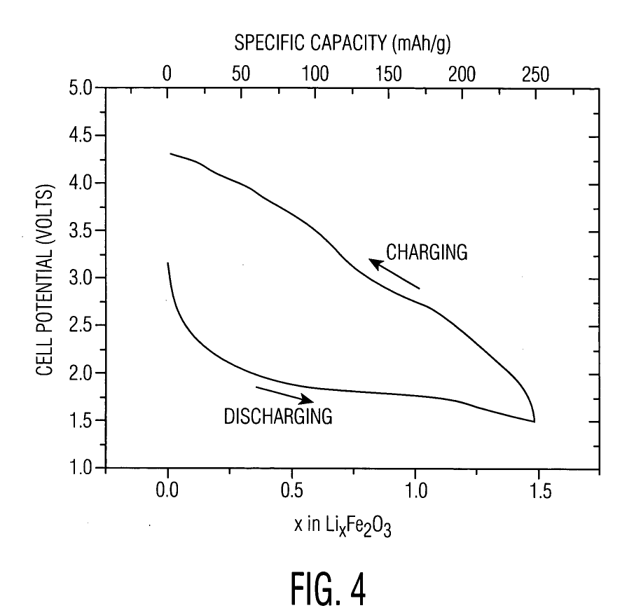

For characterizing the electrochemical properties of the synthesized iron oxide, a composite of the active material with Ketjen black carbon and polytetrafluoroethylene as the binder, in the weight ratios of 60:30:10, was prepared. This composite mix was stirred in cyclohexane for 24 hours, vacuum dried for 24 hours, and was then rolled into a composite sheet from which cathode pellets were punched. Electrochemical tests were performed in a three electrode cell with lithium metal foils as the counter and reference electrodes, and the cathode pellet as the working electrode with 1M LiClO₄ in 50:50 (by weight) propylene carbonate:dimethoxyethane as the electrolyte. At the current rate of C/50 (C_{1Li}/50 means that the current density was such that one lithium per Fe₂O₃ is intercalated in 50 hrs), a discharge capacity of about 250 mAh/g was attained between the open circuit voltage (OCV) (3.1 V) and 1.5 V, as shown in FIG. 4. This was one of the highest capacities reported for an iron oxide as a lithium intercalation host. Additionally, this large-capacity intercalation was nearly entirely reversible. When charged from 1.5 V to 4.3 V after a discharge cycle, more than 99% of the intercalated lithium was deintercalated from the oxide. This intrinsic reversibility was essential for the material to perform acceptably as an electrode material in a rechargeable battery.

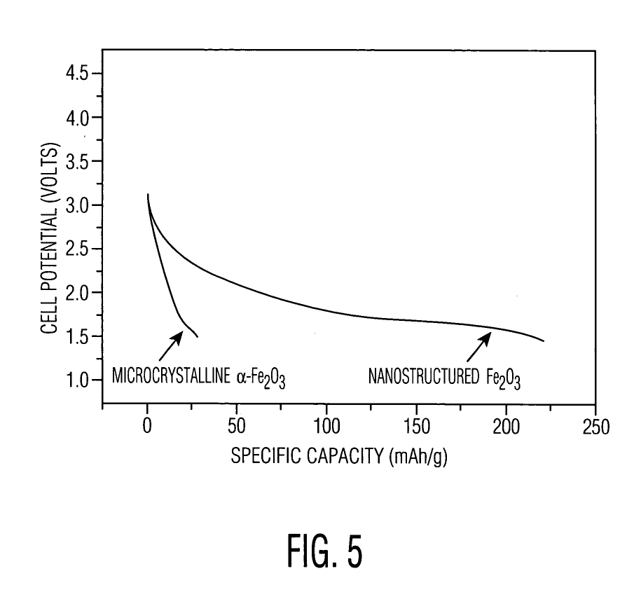

FIG. 5 shows two discharge curves, one is the first discharge curve of nanostructured iron oxide material at a discharge rate of 0.5 mA/cm². The other discharge curve is the first discharge curve of a commercial α-Fe₂O₃ sample purchased from Sigma-Aldrich Co. (St. Louis, Mo.). A comparison of the two curves highlights the contrasting properties of the two materials. The nanostructured iron oxide sample yields a capacity of 222 mAh/g. The commercial α-Fe₂O₃ sample with particles of size up to 5 μm delivers a specific of capacity of 28 mAh/g, about 8 times lower than the nanostructured iron oxide sample, with each at a current rate of 0.5 mA/cm². In other words, under similar discharging conditions, the nanostructured material lasts 8 times longer before reaching the cut-off voltage of 1.5 volts, as compared to its microcrystalline counterpart. This large difference in the specific capacity is attributed to a combination of thermodynamic and kinetic factors that lead to a higher capacity for the nanostructured material.

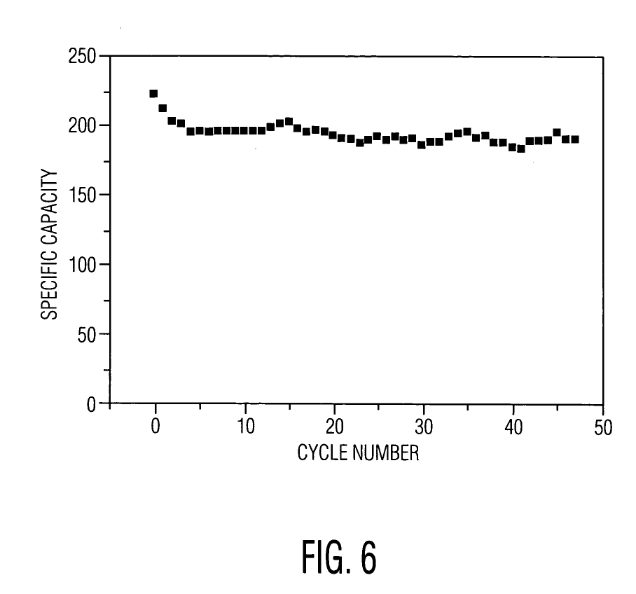

FIG. 6 shows a plot of the specific discharge capacity versus cycle number for the iron oxide material at the C_{1Li}/5 rate or about 0.5 mA/cm². It delivers an initial capacity of 222 mAh/g. The capacity stabilizes at 195 mAh/g after the first few cycles, with negligible fading over the next 40 cycles. This clearly demonstrates the excellent stability of the nanostructured iron oxide in allowing perfectly reversible charge discharge cycling. This feature is one of the most crucial factors determining the suitability of a prospective cathode candidate from an application point of view, as a rechargeable battery would be expected to yield the same discharge capacity over a large number of cycles.

The specific energy of the material at the current rate of 0.54 mA/cm² is 430 mWh/g. This value compares with 500 mWh/g for the commercially used LiCoO₂. The inventors believe that further optimization of the material may lead to higher specific energies.

Although various embodiments of the invention have been shown and described, they are not meant to be limiting. Those of skill in the art may recognize certain modifications to these embodiments, which modifications are meant to be covered by the spirit and scope of the appended claims. Various modifications of the material of the present invention can be made such as cation doped forms to retain high capacity and energy while exhibiting enhanced cycling performance and stability. The material of the present invention can readily be lithiated for use as cathodes for lithium ion batteries as well.

What is claimed is:

1. An iron oxide material capable of intercalating lithium ions comprising nanostructured phases composed of substantially amorphous nanometer sized particles.

2. The iron oxide material of claim 1, wherein the lithium ion intercalating capacity is at least 0.5 moles of lithium ions per mole of iron oxide.

3. The iron oxide material of claim 1, wherein the lithium ion intercalating capacity is at least 1.15 moles of lithium ions per mole of iron oxide.

4. The iron oxide material of claim 1, wherein the particles are less than 100 nm in size.

5. The iron oxide material of claim 1, wherein the particles are about 30 nm in size.

6. The iron oxide material of claim 1, wherein the iron oxide is Fe₂O₃.

7. The iron oxide material of claim 1, wherein the x-ray diffraction pattern of the material exhibits broad peaks with an fullwidth at half maximum value of about 0.3° to 1.5° Cu Kα 2θ.

8. The iron oxide material of claim 1, wherein the nanostructured phases are composed of particles exhibiting high meso/microporosity.

9. The iron oxide material of claim 8, wherein the particles exhibit a Brunauer-Emmett-Teller specific surface area of at least 250 m²/g.

10. The iron oxide material of claim 1 exhibiting a specific capacity of at least 80 mAh/g.

11. The iron oxide material of claim 1 exhibiting a specific capacity of at least 195 mAh/g.

12. The iron oxide material of claim 1 capable of storing energy at the level of at least 400 mWh/g.

13. The iron oxide material of claim 1 capable of storing energy at the level of from about 400 to 550 mWh/g.

14. An iron oxide material prepared by a process comprising the steps of:
oxidizing Fe(II) via hydrolysis to yield FeOOH; and
dehydrating FeOOH at a temperature and for a time sufficient to yield at least substantially amorphous nanometer size particles of Fe₂O₃.

15. The iron oxide material of claim 14, wherein said oxidizing step further comprises mixing an aqueous solution of Fe (II) with a mixture containing NaOCl and NaOH at ambient temperature to yield a reaction mixture.

16. The iron oxide material of claim 15, wherein the molar ratio of Fe(II):NaOCl:NaOH is about 1:2.5:5.

17. The iron oxide material of claim 15, further comprising stirring the reaction mixture for about 1.5 hours; and settling the reaction mixture for about 24 hours.

18. The iron oxide material of claim 17, further comprising dialyzing the reaction mixture for about 5 days through low-pass dialysis films in deionized water to yield a dialyzed material.

19. The iron oxide material of claim 18, further comprising centrifuging the dialyzed material, and freeze drying the centrifuged and dialyzed material to yield nanometer-sized powders.

20. The iron oxide material of claim 14, wherein Fe(II) is selected from the group consisting of FeCl₂, Fe(NO₃)₂, and Fe(CH₃COO)₂.

21. The iron oxide material of claim 14, wherein the dehydrating step further comprises heating FeOOH to a temperature of up to 500° C. in ambient air for about 24 hours.

22. The iron oxide material of claim 14, wherein the temperature is up to 250° C.

23. A method for preparing the iron oxide material of claim 1, comprising:
oxidizing Fe(II) via hydrolysis to yield FeOOH; and
dehydrating FeOOH at a temperature and for a time sufficient to yield nanostructured phases composed of at least substantially amorphous nanometer size particles.

24. The method of claim 23, wherein said oxidizing step further comprises mixing an aqueous solution of Fe (II) with a mixture containing NaOCl and NaOH at ambient temperature to yield a reaction mixture.

25. The method of claim 24, wherein the molar ratio of Fe(II):NaOCl:NaOH is about 1:2.5:5.

26. The method of claim 24, further comprising stirring the reaction mixture for about 1.5 hours; and settling the reaction mixture for about 24 hours.

27. The method of claim 26, further comprising dialyzing the reaction mixture for about 5 days through low-pass dialysis films in deionized water to yield a dialyzed material.

28. The method of claim 27, further comprising centrifuging the dialyzed material, and freeze drying the centrifuged and dialyzed material to yield nanometer-sized powders.

29. The method of claim 23, wherein Fe(II) is selected from the group consisting of FeCl₂, Fe(NO₃)₂, and Fe(CH₃COO)₂.

30. The method of claim 23, wherein the dehydrating step further comprises heating FeOOH to a temperature of up to 500° C. in ambient air for about 24 hours.

31. The method of claim 23, wherein the temperature is up to 250° C.
